(19) United States
(12) Patent Application Publication
(10) Pub. No.: US 2026/0072495 A1
(43) Pub. Date: Mar. 12, 2026

(54) METHOD FOR CONVERTING AUDIOVISUAL DATA INTO OLFACTORY BASED ON A DISTRIBUTED PROCESSING SYSTEM

(71) Applicant: Wai Tak Walter IP, Sheung Shui (HK)

(72) Inventors: Wai Tak Walter IP, Sheung Shui (HK); Kin Keung Kenneth LEE, Chi Fu Fa Yuen (HK)

(21) Appl. No.: 18/828,182

(22) Filed: Sep. 9, 2024

(51) Int. Cl. G06F 3/01; G06V 10/77

(52) U.S. Cl. CPC G06F 3/011; G06V 10/7715

(57) ABSTRACT

A method for converting audiovisual data into olfactory experience based on distributed processing, uses distributed processing to realize high-speed and low-latency audio and images classification. The system includes a data center, a cloud server, a data set, media content, and a base station, gaming PCs, headphones and smell generators which can be widely used in games, movies, media and other scenes. The artificial intelligence is used to identify audio or images in the scene to obtain corresponding smell feature data. For example, the sound of gunfire or the picture of a gun being fired in a movie scene can be analyzed and obtain gunpowder smell feature data. And then the smell generating unit mixes the corresponding aromatic compounds based on the above gunpowder smell feature data obtained through artificial intelligence analysis and finally releases the corresponding smell, to allow users to feel an olfactory experience in addition to vision and hearing, thereby achieving a better live experience.

### FIELD OF THE INVENTION

The present invention relates to computer filed, in particular to a system and method for quickly converting video or audio data into olfactory experience through artificial intelligence technology.

### BACKGROUND OF THE INVENTION

With the development of technology, people's demand for entertainment experiences is getting higher and higher. Hearing and vision are the key factors of entertainment. Various forms of entertainment such as movies, TV shows, and video games require high-quality sound effects to enhance the audience's entertainment experience. The high resolution of the display improves the visual experience, the surround sound system enhances the hearing experience, and even the bass system makes vibration experience by the human body. In addition to the visual and auditory experience, the olfactory experience has also attracted attention. However, odor perception is rarely realized in current entertainment systems.

However, the application of olfactory based entertainment still faces some challenges, such as how to accurately control and transmit the aroma and taste, and how to maintain the stability and consistency of the smell, etc. Therefore, olfactory based entertainment still needs more research and development to achieve a better user experience.

Now, entertainment systems with olfactory information are using predefined media data or metadata to trigger the mechanism of generating smells, and the generated smells are relatively monotonous. When the entertainment system plays a predetermined scene, the smell generating device generates the smell of the scene. However, the smell generated system based on the real-time audio data for analysis and classification, is difficult to process olfactory information in real-time with audiovisual data due to the requirement of high computing data processing speed.

Existing audio classification technology usually needs to run on a local computer. The disadvantages are slow processing speed, high latency, and heavy computing load. Especially when a large amount of data needs to be processed, it will cause a heavy burden on the local computer, causing slow processing on the computer.

To solve these problems, cloud computing technology and distributed system technology have been widely used in recent years. Cloud computing technology can concentrate computing and storage resources on the cloud, provide powerful computing and storage capabilities, and effectively solve the pressure and latency problems of local computers. Distributed system technology can distribute data and computing tasks to multiple computing nodes for processing, and at the same time has high fault tolerance and scalability, which can better support large-scale data processing.

Therefore, assigning audio and image classification calculations to distributed platforms for processing can greatly improve computing efficiency and processing speed, reduce latency, and better manage and store large amounts of media and data sets. Such technical applications will have a huge impact and application value in fields such as audio processing, audio recognition, and entertainment.

### SUMMARY OF THE INVENTION

In view of the shortcomings of the above-mentioned prior art, the present invention provides a method for converting audiovisual data into olfactory based on a distributed processing system which using a high-speed and low-latency smell classification by distributed processing, the system includes a high-speed data center, a cloud server, a data set, media content, base stations, gaming PCs, headsets and smell generators.

The present invention achieves the goals by the following technologies:

A method for converting audiovisual data into olfactory based on a distributed processing system, comprising a cloud server, a distributed processing base station, an audiovisual media storage center, an audiovisual playback unit and a smell generating device; the cloud server is deployed with an artificial intelligence model to convert audiovisual data into smell data; the distributed processing base station is deployed with an intelligent analysis model with a smell feature date set; the audiovisual media playback unit reads the audiovisual media from the audiovisual media storage center for playback, and simultaneously the audiovisual media is sent to the distributed processing base station for the intelligent analysis model to analyze the images and/or audio and obtain smell data, then transmit to the smell generating device for releasing the olfactory experience; when the intelligent analysis model cannot obtain the corresponding smell data by the smell feature date set, the relevant audiovisual media is forwarded to the cloud server, and the artificial intelligence model extracts the new smell feature data set from the images and/or audio of the audiovisual media, then update the new smell feature data set to the intelligent analysis model in the distributed processing base station.

Further, the steps of obtaining smell data from the audio of the audiovisual media include:
A1. Extracting the audio from audiovisual media;
A2. Normalizing the audio;
A3. Obtaining time-frequency domain signals by the Fourier transformation of the audio;
A4. Inputting the time-frequency domain signals into the intelligent analysis model or the artificial intelligence model to obtain corresponding sound classification data;
A5. Reading smell data corresponding to the sound classification data.

Further, the steps of obtaining smell data from the images of the audiovisual media include:
B1. Extracting the images from the audiovisual media;
B2. Preprocessing the images to form image matrixes related to the pixel intensity in the images;
B3. Inputting the image matrixes into the intelligent analysis model or the artificial intelligence model to obtain image classification data;
B4. Reading smell data corresponding to the image classification data.

Further, the distributed processing base station, the audiovisual playback unit and the smell generating device are arranged in a LAN, the cloud server is arranged in a WAN, and audiovisual media storage center is arranged in the LAN or the WAN.

Further, the devices located in the LAN are connected via wireless data transmission, including Wifi, Bluetooth, mobile network, and radio frequency transmission.

The beneficial effects of the embodiment of the present invention are:
the cloud server uses numerous media data to learn, process and analyze by artificial intelligence, and extracts feature data sets of smells and stores them in the cloud server. The distributed processing base station will regularly update the streamlined index of the smell feature data sets from the cloud server, and quickly and efficiently extract a specified number of features and store them in the distributed processing base station. When a gaming computer streams and downloads audiovideo for playback or playing games, the relevant audio and/or image signals will be sent to the local base station for analysis. The base station will use the audio and/or image to use the embedded low-cost processor (GPU) in the base station by a parallel/streaming processing method. Because the base station is generally set up locally, that is, connected to the same local area network as gaming computers, headsets, smell generating devices and other devices, thus reducing the wait time/delay to the trigger analyzing the data. When there are no related data sets of audio and/or image in the base station, the relevant audio and/or image are sent to the cloud server for joint calculation to extract the feature data sets of the audio and/or image and transmit the relevant feature data sets to the base station. At the same time, the cloud server will regularly update the feature data sets obtained by the calculation to all base stations. As a result, distributed processing can be used to greatly improve processing speed and efficiency, reduce the pressure and delay of local base station calculations, and achieve high-speed, low-latency sound classification. In addition, the use of data centers and cloud data centers can effectively store and manage large amounts of media content and data sets, which has broad application prospects.

### BRIEF DESCRIPTION OF THE DRAWINGS

The present invention will be further described below in conjunction with the accompanying drawings:

FIG. 1 is a schematic structural diagram of the present invention.

FIG. 2 is a flow chart of converting audio into smell data of the present invention.

### DESCRIPTION OF THE EMBODIMENTS

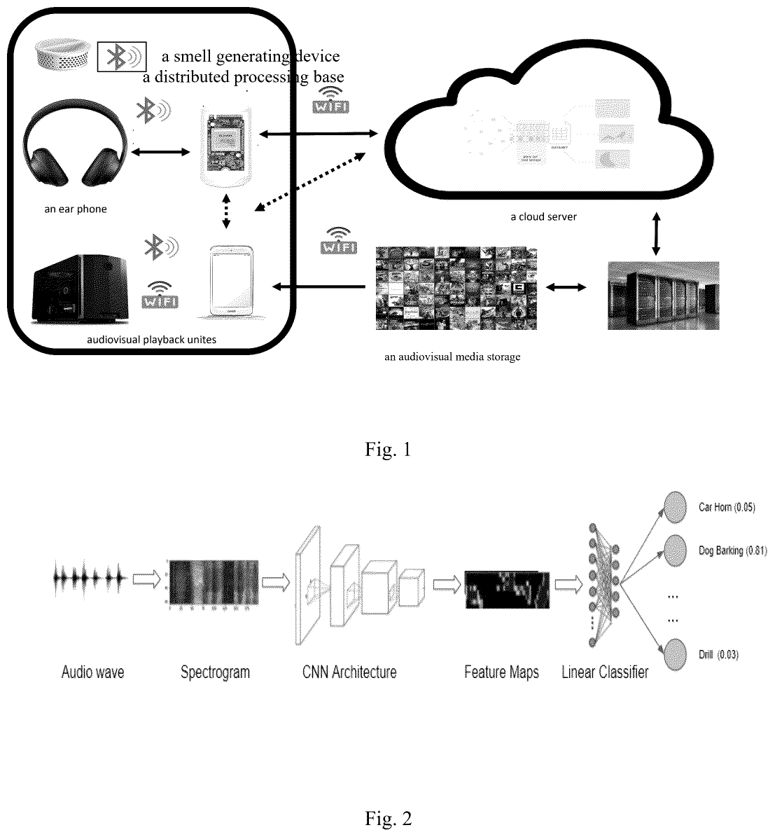

Referring to FIG. 1, a method for converting audiovisual data into olfactory experience based on distributed processing includes a cloud server, a distributed processing base station, an audiovisual media storage center, an audiovisual playback unit and a smell generating device. A GPU server with high computility is deployed in the cloud server. The artificial intelligence model that converts audiovisual data into smell data is trained and calculated to obtain smell feature data sets corresponding to the images and/or audio in the audiovisual media for new data training, running and calculating more complex models, such as multi-layer DL models (CNN, RNN types) for data set training and complex data prediction, etc. The smell feature data sets corresponding to the image and/or audio obtained after running or calculating by the cloud server are updated to the distributed processing base station. The same or similar models and algorithms are also run in the base station.

The distributed processing base station, audiovisual playback unit and smell generating device are arranged in LAN. The audiovisual playback unit reads the media to be played from the audiovisual media storage center. The relevant media includes image and/or audio data. The image and audio data are simultaneously transmitted to the audiovisual playback unit and the distributed processing base station of the LAN. The LAN transmission speed is fast which can improve the system response, and at the same time, it will not initiate too many access requests to the cloud server, causing network congestion, and reduce the computing pressure of the cloud server. The intelligent analysis model with smell feature data sets is also deployed in the distributed processing base station. The intelligent analysis model can compute the image and audio data played by the audiovisual playback unit in real time to obtain the corresponding smell feature data which will be transmitted to the smell generating device for releasing smell experience, thereby increasing the user's live experience.

The following describes in detail how distributed processing base stations and cloud servers convert audio in audiovisual media into smell feature data. Referring to FIG. 2, the specific steps are as follows:
A1.The audiovisual media storage center sends audiovisual media according to the request of the audiovisual playback unit, and at the same time transmits the audio of the audiovisual media to the distributed processing base station or cloud server. Usually, the audio is processed in real time in the form of files such as. wav or analogue signals to input into the distributed processing base station or the cloud server.
A2.The distributed processing base station or cloud server normalizes the audio, including sampling, intercepting specified length of the audio, etc.
A3.The audio is Fourier transformed (short-time Fourier transform) to convert the time domain representation of the audio into a time-frequency domain signal.
A4.Input time-frequency domain signals into intelligent analysis models or artificial intelligence models. The intelligent analysis model in the distributed processing base station and the artificial intelligence model in the cloud server input time-frequency domain signals into a convolutional neural network (CNN) to obtain feature maps, and then classify the features by a classifier to predict and obtain classification data of smells corresponding to audio.
A5.The smell feature data corresponding to the above classification data is read and then sent to the smell generating device. The smell generating device mixes different smells released by the smell generating units in proper percentages according to the smell feature data to obtain the right smell and releases it.

The following describes in detail how the base station converts image signals of the audiovisual media into smell feature data. The specific steps are as follows:
B1.The audiovisual media storage center sends audiovisual media by the request of the audiovisual playback unit, and simultaneously transmits the image of the audiovisual media to the distributed processing base station or cloud server.
B2.The distributed processing base station or cloud server pre-processes the image to form an image matrix related to the pixel intensity.
B3.Input the image matrix into the intelligent analysis model or artificial intelligence model, which includes convolutional neural network (CNN) computes to obtain feature maps, and then the classifier predicts the category of the image features to obtain the smell feature data corresponding to an image.
B4.According to the above classification data, the smell feature data is read and then sent to the smell generating device. The smell generating device mixes different smells released by the smell generating units in proper percentages according to the smell feature data to obtain the right smell and releases it.

The present invention can be widely used in games, movies, media and other scenes. The artificial intelligence is used to identify audio or images in the scene to obtain corresponding smell feature data. For example, the sound of gunfire or the picture of a gun being fired in a movie scene can be analyzed and obtain gunpowder smell feature data. And then the smell generating unit mixes the corresponding aromatic compounds based on the above gunpowder smell feature data obtained through artificial intelligence analysis and finally releases the corresponding smell, to allow users to feel an olfactory experience in addition to vision and hearing, thereby achieving a better live experience.

The above are only preferred embodiments of the present invention. The present invention is not limited to the above-mentioned embodiments. As long as the technical effects of the present invention are achieved by the same means, any modification can be made within the spirit and principles of the present disclosure. Any modifications, equivalent substitutions, improvements, etc. shall be included in the scope of protection of this disclosure. All belong to the protection scope of the present invention. Various modifications and changes may be made to the technical solutions and/or implementations within the scope of the present invention.

1. A method for converting audiovisual data into olfactory based on a distributed processing system, comprising a cloud server, a distributed processing base station, an audiovisual media storage center, an audiovisual playback unit and a smell generating device; the cloud server is deployed with an artificial intelligence model to convert audiovisual data into smell data; the distributed processing base station is deployed with an intelligent analysis model with a smell feature date set; the audiovisual media playback unit reads the audiovisual media from the audiovisual media storage center for playback, and simultaneously the audiovisual media is sent to the distributed processing base station for the intelligent analysis model to analyze the images and/or audio and obtain smell data, then transmit to the smell generating device for releasing the olfactory experience; when the intelligent analysis model cannot obtain the corresponding smell data by the smell feature date set, the relevant audiovisual media is forwarded to the cloud server, and the artificial intelligence model extracts the new smell feature data set from the images and/or audio of the audiovisual media, then update the new smell feature data set to the intelligent analysis model in the distributed processing base station.

2. The method for converting audiovisual data into olfactory based on the distributed processing system of claim 1, wherein the steps of obtaining smell data from the audio of the audiovisual media include:
A1. Extracting the audio from audiovisual media;
A2. Normalizing the audio;
A3. Obtaining time-frequency domain signals by the Fourier transformation of the audio;
A4. Inputting the time-frequency domain signals into the intelligent analysis model or the artificial intelligence model to obtain corresponding sound classification data;
A5. Reading smell data corresponding to the sound classification data.

3. The method for converting audiovisual data into olfactory based on the distributed processing system of claim 1, wherein the steps of obtaining smell data from the images of the audiovisual media include:
B1. Extracting the images from the audiovisual media;
B2. Preprocessing the images to form image matrixes related to the pixel intensity in the images;
B3. Inputting the image matrixes into the intelligent analysis model or the artificial intelligence model to obtain image classification data;
B4. Reading smell data corresponding to the image classification data.

4. The method for converting audiovisual data into olfactory based on the distributed processing system of claim 1, wherein the distributed processing base station, the audiovisual playback unit and the smell generating device are arranged in a LAN, the cloud server is arranged in a WAN, and audiovisual media storage center is arranged in the LAN or the WAN.

5. The method for converting audiovisual data into olfactory based on the distributed processing system of claim 4, wherein the devices located in the LAN are connected via wireless data transmission, including Wifi, Bluetooth, mobile network, and radio frequency transmission.
